(19) United States
(12) Patent Application Publication
(10) Pub. No.: US 2001/0013187 A1
(43) Pub. Date: Aug. 16, 2001

(54) MAGNETICALLY MOUNTED BOARD FOR DISPLAYING FLAT ARTICLES

(76) Inventors: STEPHEN HARRY DWYER, WOODBURY, MN (US); KOLLIN IGNATIUS SCHAMMEL, EAGAN, MN (US); SHEILA GERETTE DWYER, WOODBURY, MN (US)

Correspondence Address: STEPHEN H DWYER, 3616 BAILEY RIDGE CIRCLE, WOODBURY, MN, 55125

(21) Appl. No.: 09/323,356

(22) Filed: Jun. 1, 1999

Related U.S. Application Data
(60) Provisional application No. 60/088,471, filed on Jun. 8, 1998.

(51) Int. Cl. G09F 7/04

(52) U.S. Cl. 40/600

(57) ABSTRACT

A magnetically mounted display board has a rear surface providing magnetic support, a display panel which removably holds flat articles for display, and a transparent protectant for viewing and protection of the displayed articles. The display panel and the transparent protectant are bound together with a binding tape. This allows one to display photos, childrens artwork, calendars, post cards and other flat articles on a refrigerator in a creative, organized and protected fashion.

This patent application claims the benefit of prior filed copending provisional patent No. 60/088,471 filed Jun. 8, 1998.

### BACKGROUND OF THE INVENTION

1) Field of the Invention

The present invention is directed to a suitable method of organizing protecting, displaying and framing household, school, and office display articles.

2) Description of Prior Art

Various magnets have been developed to mount articles to objects such as a refrigerator door.

### SUMMARY OF INVENTION

According to the present invention, the display board is comprised of a display panel, a transparent protective sheet, and one or more magnetic support members. The display board may include an adhesive, which allows for the removability of the display articles. The magnetic support member may comprise of four magnets, one in each corner of the display board. The display board may have printed designs along the periphery of the display panel or the protective sheet to allow for creative designs or seasonal themes.

The display panel area is ideally suited for a collection of flat articles spaced adequately apart from each other to allow the protective sheet to removably adhere to the display panel. The lift off force of the protective sheet and flat articles from the display panel should be less than the magnetic support member lift off force from the magnetically attractive surface.

The method of displaying articles using this display board is to place the magnetic support members on a magnetically attractive surface; peel the protective sheet away from the display panel; position an article on the display panel; and replace the protective sheet over the article and the display panel. By designing the display panel to extend approximately ⅜ inch past the length of the protective sheet and by extending the protective sheet approximately ⅛ inch past the adhesive it provides for easy lift off of protective sheet and an area for imprinting, product identification or other such labeling.

### BRIEF DESCRIPTION OF THE DRAWINGS

FIG. 1 is a side view of a display board according to one embodiment of the present invention.

FIG. 2 is a front isometric view of a refrigerator having the display board of FIG. 1 magnetically mounted to it.

FIG. 3 is a front view of the display board of FIG. 1.

### DESCRIPTION OF THE PREFERRED EMBODIMENTS

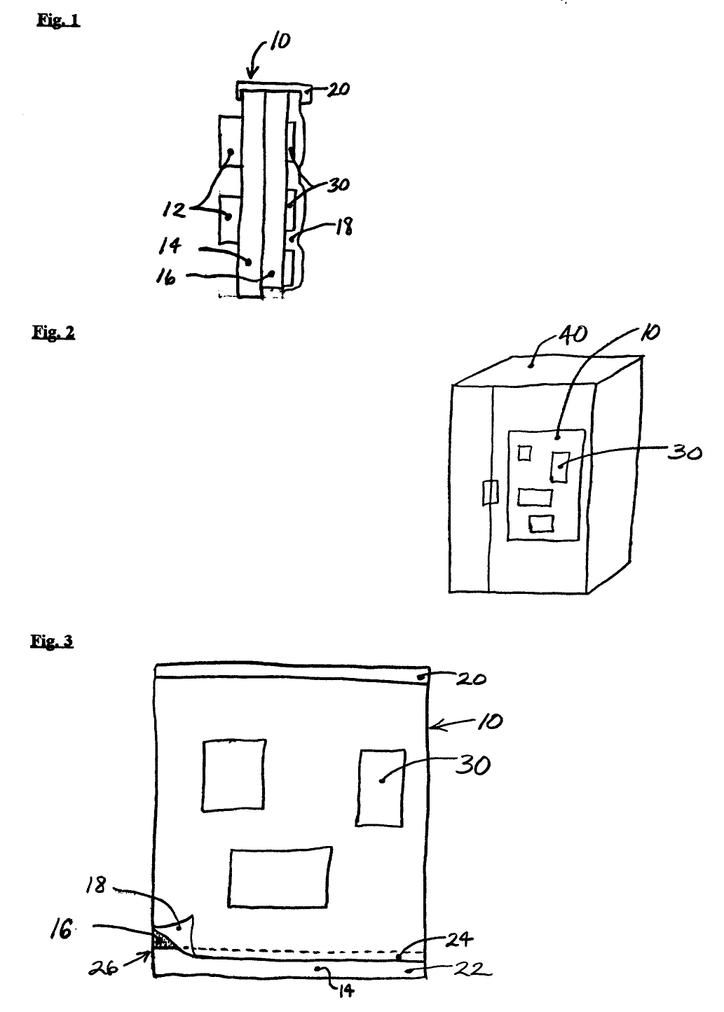

A magnetically mounted display board 10 according to one embodiment of the present invention is shown in side view in FIG. 1. Display board 10 comprises one or more magnetic support members 12, a display panel 14, optional adhesive 16, and transparent protective layer 18. Elements 12, 14, and 18 may be secured together at one edge by a binder 20 or elements 14 & 18 may be secured together at one edge by a binder 20.

Articles 30 to be displayed are provided between display panel 14 and protective layer 18.

Display board 10 may be magnetically secured by magnetic support members 12 to any magnetically attractive surface, such as a refrigerator, 40 as shown in FIG. 2.

As shown in FIG. 3, display board 10 may have a display panel 14 which is longer than protective layer 18, thereby allowing an area 22 for product labeling or printing. Additionally, the length of optional adhesive layer 16 may be shorter than the length of protective layer 18, thereby creating region 24. This allows for the easy peeling off of protective layer 18 from adhesive layer 16 at corner 26, as shown in FIG. 3.

Magnetic support member 12 may be a flat magnet, such as a 20 or 30 or 40 thousands of an inch thick flat magnet obtainable from various magnet suppliers.

Display panel 14 may be a card stock with adhesive, or flat magnet (see above) with adhesive, or a statically attractive material, such as 16 point or 20 lb. card stock with adhesive, a 40 thousands of an inch thick flat magnet with adhesive, or a static cling like material.

Optional adhesive layer 16 may be an acrylic adhesive, such as a low tack acrylic adhesive that is coated or provided as a transfer adhesive, preferably allowing for removeability of display articles.

Protective layer 18 should be a transparent sheet, such as a 2 thousands of an inch thick polyester or polyproylene plastic or pvc film. Preferably low-kink, pliable, and ph nuetral to allow for archivability of display articles.

Protective layer 18 should be secured along an edge of display board 10 so that the protective layer may be peeled off of display panel 14 to allow the user to insert, remove, and exchange articles 30 being displayed on the display board. Materials used to secure this edge may be a binding material like that used on Hallmark brand photo album pages, available from Hallmark Cards Inc., Kansas City, Mo., as product number AR6555 or VPC binding tape, available from Vital Presentation Concepts, Inc., St.Paul, Minn., as product number #788WIP788.

It will thus be seen that the present invention provides a product and method to removably display, frame, position, organize, and protect a plurality of display articles such as photos, calendars, current events, schedules, children's art, etc . . . on any magnetically attractive surface. In addition, the present invention enhances interaction with display articles without destruction of the display articles by touch, scratch, or without otherwise dirtying, damaging or destroying display articles.

What is claimed:

1. A display board comprising, in order:
at least one magnetic support member for securing the display board to a magnetically attractive surface;
a display panel secured to at least one magnetic support member;
a transparent protective sheet secured to the display panel along a side edge, wherein flat articles may be removably displayed between the panel and protective sheet, and wherein the protective sheet is secured to the display panel along a side edge of the panel and is otherwise removably adhered to panel so protective sheet is removably secured to panel over its area.

2. The display board of claim 1, wherein the display panel further includes an adhesive on the display panel for securing the flat articles to the display panel.

3. The display board of claim 2, wherein the adhesive for securing the flat articles to the display panel allows for removability of the display articles.

4. The display board of claim 1, wherein at least one magnetic support member comprises at least four planar magnets.

5. The display board of claim 1, further comprising printed designs provided at the periphery of the protective sheet.

6. The display board of claim 1, further comprising printed designs provided at the periphery of the display panel.

7. The display board of claim 1, further comprising a plurality of articles spaced from each other between the protective sheet and display panel.

8. The display board of claim 7, wherein the area of articles being displayed is sufficiently smaller than area of total available area of removable contact between protective sheet and display panel to allow the protective sheet to removably adhere to the display panel.

9. The display board of claim 1, wherein protective sheet lift-off force from the display panel is less than at least one magnetic support members lift-off force from the magnetically attractive surface.

10. The display board of claim 1, wherein article lift-off force from display panel is less than at least one magnetic support members lift-off force from the magnetically attractive surface.

11. The display board of claim 2, wherein the adhesive ends approximately ½″ short of one edge, and the protective sheet ends approximately ⅜″ short of the same edge to allow for easy lift-off of protective sheet and an area for imprinting, product identification or other such labeling.

12. The display board of claim 11, wherein the display board is rectangular and wherin the protective sheet is detachable from at least two edges of the display panel.

13. A method of displaying planar articles, comprising the steps of:
providing a display board comprising:
at least one magnetic support member for securing the display board to a magnetically attractive surface;
a display panel; and
a transparent protective sheet, wherein flat articles may be removably displayed between the panel and protective sheet, and wherein the protective sheet is secured to the display panel along a side edge of the panel and is otherwise removably adhered to panel so protective sheet is removably secured to panel over its area;
placing at least one magnetic support member on a magnetically attractive surface;
peeling the protective sheet away from the display panel;
positioning an article on the display panel; and
replacing the protective sheet over the article and the display panel.

14. The display board of claim 13, wherein the display panel further includes an adhesive for securing the flat articles to the display panel.

15. The display board of claim 14, wherein the adhesive for securing the flat articles to the display panel is removable.

16. The display board of claim 13, wherein at least one magnetic support member comprises at least four planar magnets.

17. The display board of claim 13, wherein the area of article is sufficiently smaller than area of total available area of removable contact between protective sheet and display panel to allow the protective sheet to removably adhere to display panel.

18. The display board of claim 13, wherein protective sheet lift-off force from display panel is less than the magnetic support member lift-off force from the magnetically attractive surface.

19. The display board of claim 13, wherein the flat article lift-off force from the display panel is less than the magnetic support member lift-off force from the magnetically attractive surface.

20. The display board of claim 14, wherein the adhesive ends approximately ½″ short of one edge, and the protective sheet ends approximately ⅜″ short of the same edge to allow for easy lift-off of protective sheet and an area for imprinting, product identification, or other such labeling.
